(19) United States
(12) Patent Application Publication
(10) Pub. No.: US 2015/0200906 A1
(43) Pub. Date: Jul. 16, 2015

(54) MANAGING PENDING ELECTRONIC MESSAGE RESPONSES

(71) Applicant: Jaikumar GANESH, San Francisco, CA (US)

(72) Inventor: Jaikumar GANESH, San Francisco, CA (US)

(73) Assignee: GOOGLE INC., Mountain View, CA (US)

(21) Appl. No.: 13/488,352

(22) Filed: Jun. 4, 2012

(51) Int. Cl. H04L 12/58; H04L 29/08

(52) U.S. Cl. CPC H04L 51/34; H04L 67/10

(57) ABSTRACT

A computer-implemented method for managing pending electronic message responses is provided. The method includes accessing, using a processor, information for determining whether a response is expected for a pending electronic message, and analyzing the pending electronic message based on the accessed information to determine that a response to the pending electronic message is expected from a recipient of the electronic message. The method also includes providing the pending electronic message to the recipient, and monitoring for the response to the pending electronic message, by monitoring incoming electronic messages to determine if the response to the pending electronic message is received. The method further includes, if no response is received within a predetermined period of time, providing for notifying a sender of the pending electronic message. Systems and machine-readable media are also provided.

### TECHNICAL FIELD

The present disclosure generally relates to managing electronic messages, and more particularly to managing pending electronic message responses.

### BACKGROUND

Communications are conducted through electronic messages such as, for example, emails. The electronic messages may be sent to recipients, and responses may be received.

### SUMMARY

The disclosed subject matter relates to a computer-implemented method for managing pending electronic message responses. The method includes accessing, using a processor, information for determining whether a response is expected for a pending electronic message, analyzing the pending electronic message based on the accessed information to determine that a response to the pending electronic message is expected from a recipient of the electronic message, and providing the pending electronic message to the recipient. The method also includes monitoring for the response to the pending electronic message by monitoring incoming electronic messages to determine if the response to the pending electronic message is received. The method further includes providing for notifying a sender of the pending electronic message if no response is received within a predetermined period of time. Systems and machine-readable media are also provided.

The disclosed subject matter further relates to a system for managing pending electronic message responses. The system includes a memory storing response expectancy information for determining whether a response is expected for a pending email and executable instructions, and a processor. The processor is coupled to the memory and is configured to execute the stored executable instructions to analyze the pending email based on the response expectancy information to determine that a response to the pending email is expected from a recipient of the pending email, include the pending email in a pending response list, and provide the pending email to the recipient. The processor is further configured to monitor incoming emails to determine if the response to the pending email included in the pending response list is received, and remove the pending email from the pending response list if the response to the pending email is received.

The disclosed subject matter also relates to a machine-readable storage medium including machine-readable instructions for causing a processor to execute a method for managing pending electronic message responses. The method includes accessing a predetermined keyword for determining whether a response is expected for a pending electronic message, and analyzing the pending electronic message to identify the accessed predetermined keyword from a pending email. The method also includes determining that the response to the pending email is expected based on the identified predetermined keyword if the accessed predetermined keyword is identified in the pending electronic message, including the pending email in a pending response list, and providing the pending email to the recipient. The method further includes monitoring incoming emails to determine if the response to the pending email included in the pending response list is received, removing the pending email from the pending response list if the response to the pending email is received, and providing a reminder to the recipient of the pending email that no response is received for the pending email within the predetermined period of time if no response is received within a predetermined period of time.

It is understood that other configurations of the subject disclosure will become readily apparent to those skilled in the art from the following detailed description, wherein various configurations of the subject disclosure are shown and described by way of illustration. As will be realized, the subject disclosure is capable of other and different configurations and its several details are capable of modification in various other respects, all without departing from the scope of the subject disclosure. Accordingly, the drawings and detailed description are to be regarded as illustrative in nature and not as restrictive.

### BRIEF DESCRIPTION OF THE DRAWINGS

Certain features of the subject disclosure are set forth in the appended claims. However, for purposes of explanation, several embodiments of the subject disclosure are set forth in the following figures.

FIG. 1 illustrates an example architecture for managing pending electronic message responses.

FIG. 2 illustrates an example system for managing pending electronic message responses.

FIG. 3 is a schematic diagram illustrating example operations for managing pending electronic message responses.

FIG. 4 illustrates a flow diagram of example operations for managing pending electronic message responses.

FIG. 5 is a conceptual diagram illustrating an example electronic system with which some implementations of the subject disclosure can be implemented.

### DETAILED DESCRIPTION

The detailed description set forth below is intended as a description of various configurations of the subject disclosure and is not intended to represent the only configurations in which the subject disclosure may be practiced. The appended drawings are incorporated herein and constitute a part of the detailed description. The detailed description includes specific details for the purpose of providing a thorough understanding of the subject disclosure. However, it will be clear and apparent to those skilled in the art that the subject disclosure is not limited to the specific details set forth herein and may be practiced without these specific details. In some instances, well-known structures and components are shown in block diagram form in order to avoid obscuring the concepts of the subject disclosure.

When sending out electronic messages such as, for example, emails, users may be expecting a response back from the recipient. For example, a sender may send out an email for scheduling a meeting with the recipient, and may propose a location. The sender may remember to check periodically whether he or she has received a response from the recipient regarding the proposed location. If the sender discovers that no response is received after a certain period of time, he or she may send out a reminder.

If there are multiple such electronic messages for which the sender is waiting responses, there may be a need for an efficient method and/or system to identify, keep track of all such electronic messages, and remind the sender to follow up if no response is received after a certain period of time. Using existing systems, the sender may manually identify electronic messages for which a response is expected/required, and rely on his or her organization skills to track and follow up on such messages. This process is typically cumbersome, inefficient, and may be prone to the sender failing to follow up on the messages before being too late.

According to the various aspects of the subject disclosure, a system and method for managing pending electronic messages is provided. The system may monitor the electronic messages being sent out by the sender and may automatically identify if the sender is likely expecting a response to the electronic message from the recipient. Specifically, in some aspects of the subject disclosure, the system may analyze the contents of the electronic message sent out and look for certain keywords which may signify that a response is expected. For emails, the contents may be stored in the body of the email. For example, the system may identify keywords such as “please reply”, “expecting a response”, and “please get back to me”, and automatically determine that the sender is expecting a response from the recipient.

The system may also look for other signals to determine whether a response is expected. The system may analyze the sender's previous electronic messages for which response was received, and identify any clues or patterns. For example, if the sender's previous messages which received responses consistently included a certain phrase, next time, a message by the sender containing the same phrase may be identified as expecting a response.

The relationship between the sender and the recipient may also tell the system that a response is expected from the recipient. Specifically, for example, if the recipient is a person from whom the sender has frequently sought responses before, the system may automatically determine that a response is expected from the recipient based on the identity of the recipient. As another example, the system may determine that electronic messages for which the sender's manager is copied had frequently received a response. In that case, next time the manager is copied in an electronic message, the system may identify the electronic message as expecting a response.

The keywords, signals, relationships discussed above and other information which may be used for determining whether a response is expected for a pending electronic message may be stored in a datastore. The datastore may be integrated with a memory of the system, or may be an independent datastore which is in communication with the system.

In some aspects of the subject disclosure, the sender may have on option to manually override the system's determination that an electronic message is expecting a response. For example, after determining that an electronic message is expecting a response, the system may prompt the sender to confirm its determination. If the sender agrees, then the system may proceed with sending the message. If the sender decides that no response is expected, then the sender may manually override the system's determination. In another aspect of the subject disclosure, the sender may be given an option to check that no response is required before pressing “send.”

After the system determines that an electronic message is expecting a response and the message has been sent to the recipient, the message may be tagged, labeled, or otherwise indicated that a response is expected for the electronic message. The system may use such tags, labels or other indicators to track and manage the pending responses. Electronic messages for which responses are expected may also be put in a pending response list for tracking the responses. A default wait period may be set by the system, and if no response is received within the wait period, a notification may be made to the sender that no response is yet received. The sender may also be given an option to adjust the default wait period.

If a response is received, the system may automatically remove the electronic message from the pending response list. In an aspect of the subject disclosure, the sender may be notified before the electronic message is removed from the pending response list. The system may also provide the sender an option to remove the electronic message manually from the pending response list. For example, the recipient may not have directly responded to the electronic message, but may have responded by a different mode, such as a telephone call. In that case, the sender may manually remove the electronic message from the pending response list.

The activities for managing pending electronic messages described above may be processed at an electronic message server (e.g., email server) or other types of servers having access to a computer network. The activities may also be processed at an electronic message client (e.g., email client) at a local system. The activities may also be processed by a server in conjunction with a client.

While the following descriptions may generally refer to emails, the subject disclosure is not limited to emails, and may be applied to other electronic messages for which responses may be received such as, for example, text messages, chat room messages, instant messaging service messages, social networking service posts or messages, blog posts, audio messages, and video messages.

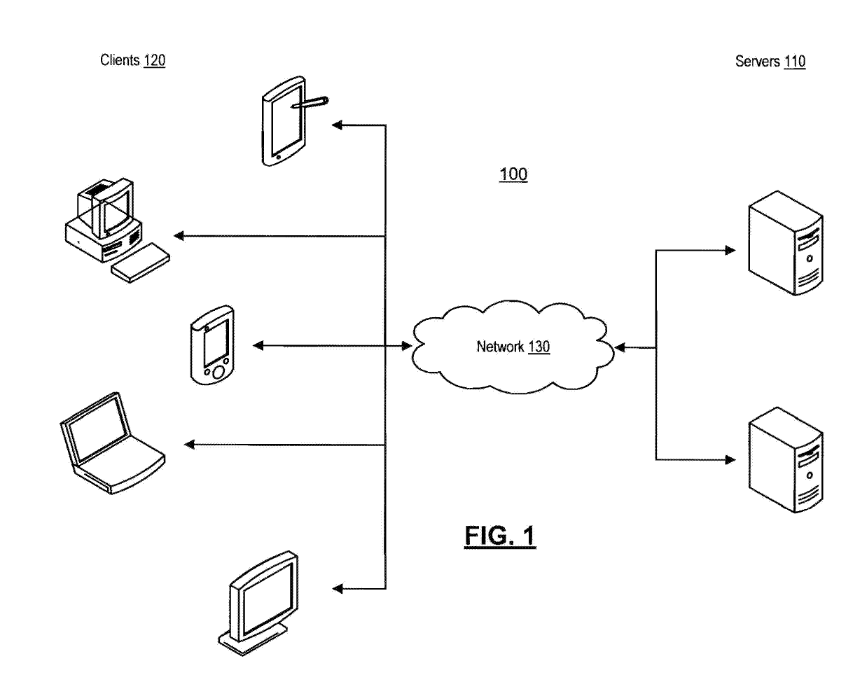

Turning to the drawings, FIG. 1 illustrates an example architecture 100 for managing pending electronic message responses. The architecture 100 includes servers 110 and clients 120 connected over a network 130. Each of the clients 120 may interact with users, and communicate with the servers 110 to send electronic messages (e.g., emails) and manage pending responses to the electronic messages. The servers 110 may be any device having a processor, memory, and communications capability for communicating with the clients 120, sending electronic messages, and managing pending electronic message responses. The clients 120 may be, for example, desktop computers, laptop computers, mobile devices (e.g., a smart phone, tablet computer, or PDA), set top boxes (e.g., for a television), televisions, video game consoles, home appliances (e.g. a refrigerator, microwave oven, washer, or dryer) or any other devices having appropriate processor, memory, and communications capabilities for sending electronic messages and managing pending responses.

The network 130 may include, for example, any one or more of a personal area network (PAN), a local area network (LAN), a campus area network (CAN), a metropolitan area network (MAN), a wide area network (WAN), a broadband network (BBN), the Internet, and the like. Further, the network 130 can include, but is not limited to, any one or more of the following network topologies, including a bus network, a star network, a ring network, a mesh network, a star-bus network, tree or hierarchical network, and the like. In an aspect of the subject disclosure, the system 100 may comprise only servers 110, or may comprise only clients 120, in communication with the network 130.

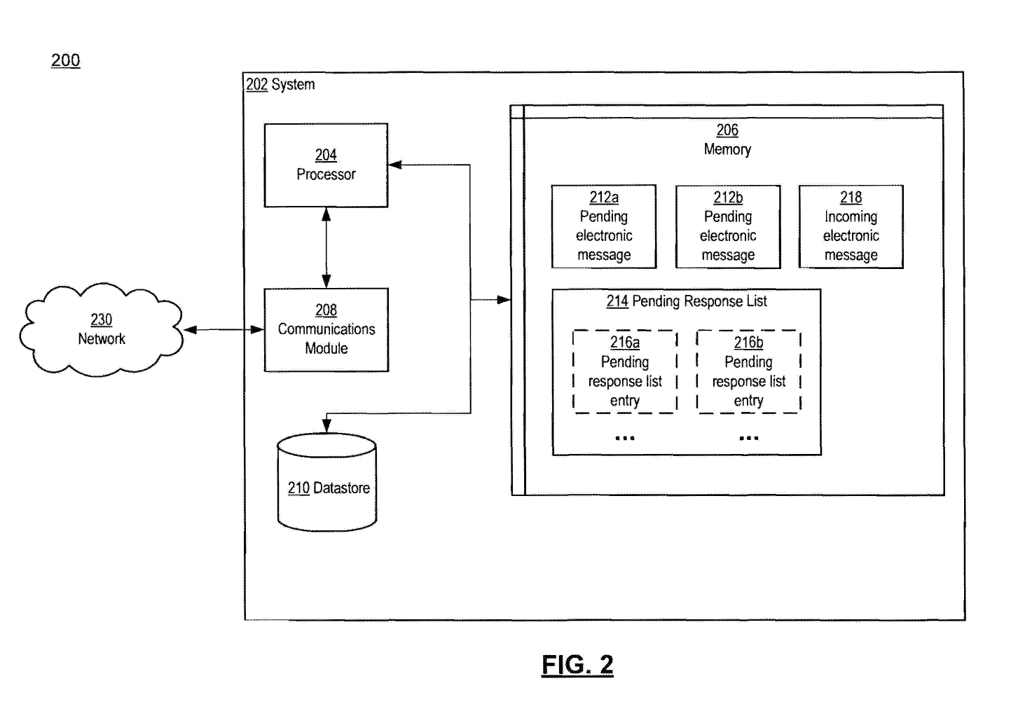

FIG. 2 is a block diagram 200 illustrating an example system 202 for managing pending electronic message responses. The system 202 may be implemented in the server 110, in the client 120, or across the server 110 and the client 120. The system 202 is connected to a network 230 (e.g., network 130) via a communications module 208. The communications module 208 is configured to interface with the network 230 to send and receive information, such as data, requests, responses, and commands to the other devices or systems on the network to manage pending responses to electronic messages (e.g., emails). The communications module 208 may be, for example, modems, Ethernet cards or mobile broadband adaptors.

The system 202 includes a processor 204, a memory 206, and the communications module 208. The memory 206 includes pending electronic messages, such as pending electronic messages 212a and 212b, for sending to recipients and for which response are expected and pending. The electronic messages may be, for example, emails, text messages, chat messages, instant messaging service messages, social networking service posts, and blog posts. The memory 206 also includes a pending response list 214. The pending response list 214 includes entries such as entries 216a and 216b including information on pending electronic messages for which a response is pending and monitored. The information included in the entries may be identifiers for the corresponding pending electronic messages. The information included in the entries may also be copies of the corresponding pending electronic messages. The information may also be other types of information which may be used to identify whether a response is received for the corresponding pending electronic message.

In an aspect of the subject disclosure, the system 202 may also include a datastore 210, and the pending response list 214 is stored in the datastore. The datastore 210 may be implemented to be independent from the system 202 and in communication with the processor 204, or may be implemented in the system 202 as shown in FIG. 2. The datastore 210 may also store information for determining whether a response is expected for the pending electronic messages 212a-b. For example, such information may include response patterns for previous electronic messages for which responses were received, and predetermined relationships and keywords which may signal that a response may be expected for the pending electronic messages 212a-b.

The processors 204 may be configured to execute instructions, such as instructions physically coded into the processors, instructions received from software in memory 206, or a combination of both. For example, the processor 204 executes instructions to access, at a datastore (e.g., datastore 210), information for determining whether a response is expected for a pending electronic message, analyzing the pending electronic message based on the access information to determine that a response to a pending electronic message (e.g., pending electronic messages 212a and 212b) is expected from a recipient, and provide the pending electronic message to the recipient. The processor 204 may also be configured to monitor for a response to the pending electronic message that was provided to the recipient. Monitoring for the response includes monitoring incoming electronic messages to determine if a response is received for the pending electronic message. The processor 204 is further configured to generate a notification to a sender of the pending electronic message that was provided to the recipient if no response is received within a predetermined period of time.

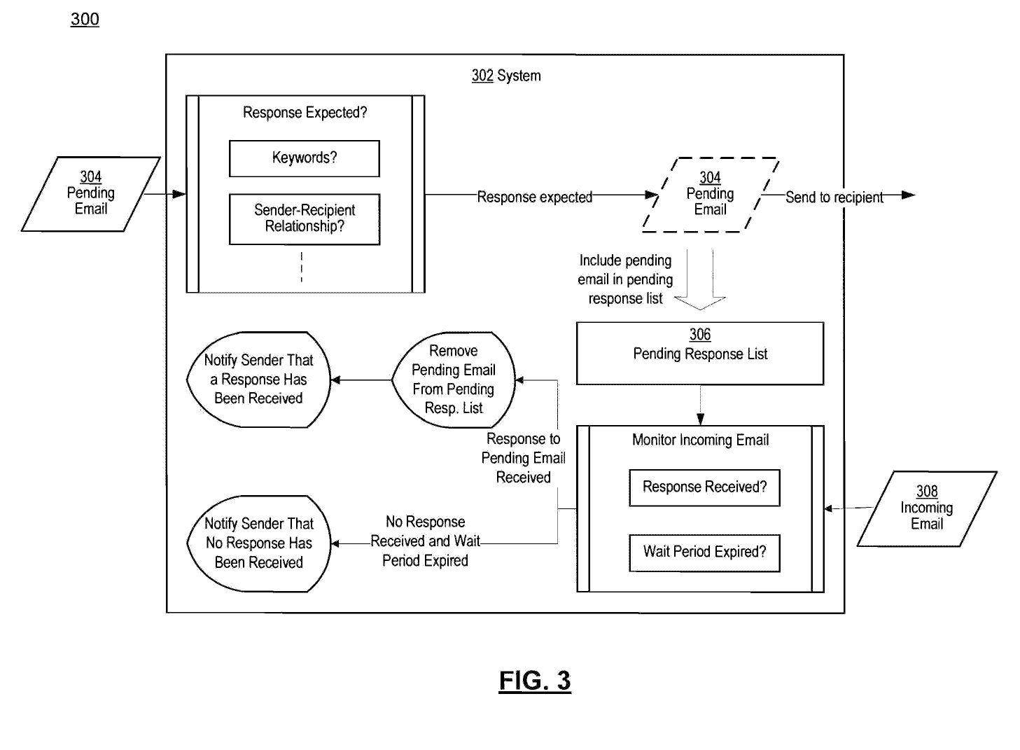

FIG. 3 is a schematic diagram 300 illustrating example operations for managing pending electronic message responses. Diagram 300 shows an example where the pending electronic messages (e.g., pending electronic messages 212a and 212b) are emails. The operations may be performed by a processor (e.g., processor 204) of a system 302 (e.g., system 202).

A sender drafts a pending email 304 (e.g., pending electronic message 212a or 212b) for sending to a recipient. Next, the system 302 analyzes the pending email 304 to determine whether a response is expected from the recipient of the email. Determining whether a response is expected may be performed in various ways. In one example, the system 302 may look for any keywords in the pending email 304 which may signal that a response is expected. For example, the contents of the pending email 304 may include phrases such as “please reply”, “expecting a response”, “please get back to me,” “I look forward to hearing back from you,” or other similar phrases that signals that the sender is expecting a response from the recipient. Such keywords may be predefined. The system 302 may look for such keywords in the pending email 304, and if one is found, determine that a response is expected and pending for the pending email 304.

In another example, the system 302 may determine whether a response is expected by analyzing if the relationship between the sender and the recipient of the pending email 304 signals that a response may be expected. The types of relationships which signal an expectation of a response may be predetermined. Information on such predefined types of relationships may be stored in a memory or a datastore of the system 302. The memory may be, for example, the memory 206, and the datastore may be, for example, the datastore 210. The system 302 may reference the stored relationship information in determining whether a response is expected for the pending email 304. The predetermined relationship may be, for example, an employee-manager relationship. An email being sent by an employee to his or her manager may always seek a response, and such employee-manager relationship may be predefined as one which signals an expectation of response. Other relationships such as, for example, a manager-employee relationship (emails from manager to his/her employee or vice versa), or a firm-client relationship (emails going from the firm to the client or vice versa) may also be predefined as signaling expectation of a response. Other custom relationships which may signal an expectation of response may also be predefined and stored for reference by the system 302.

In yet another example, the system 302 may analyze the sender's previous emails for which a response was sought and/or received, and identify any clues or patterns which signal expectation of response. For example, if the system 302 determines that the sender's email to a specific recipient had frequently (e.g., exceeding a predefined number) received a response in the past, the system may recognize the recipient and determine that future emails being sent to this recipient will also be expecting a response. The system 302 may also determine that when a specific recipient (e.g., sender's manager) was copied on the sender's email, the email had a significantly high response rate, and determine that future emails copying such recipient are expecting a response. The system 302 may also look for other clues or patterns. For example, emails sent out by the sender on a certain day of the week may have had a significantly higher rate of receiving responses. Emails that were addressed to more than a certain number of recipients may have had a significantly higher rate of receiving responses. Other clues or patterns may also be used.

If the system 302 determines that a response is being expected on the pending email 304, the information on the pending email is placed in a pending response list 306 (e.g., pending response list 214), and the pending email is sent out to the intended recipient or recipients. Information included in the pending response list 306 may be a copy of the pending email 304, or may be other identifiers or pieces of data having sufficient information to identify the pending email 304 and to determine whether a response has been received for the pending email. Rather than using the pending response list 306, the system 302 may also utilize methods such as tagging, labeling or other methods to identify and manage pending emails for which a response is determined to be expected.

In an aspect of the subject disclosure, the sender may be given an option to review the determination that a pending email is expecting a response, and to manually override the determination. For example, after the system 302 determines that a response is expected for a pending email, the sender may be prompted with the result of such determination. The sender may review the prompt, and may decide to accept the determination, or to override it. If the sender decides to override the determination that a response is expected for the pending email, information of the pending email is not put into the pending response list 306, and the system 302 will not monitor whether a response is received for the pending email.

If the sender does not override the determination that a response is expected on the pending emails that are sent out (e.g., pending email 304), the system 302 monitors incoming emails to determine if any of the incoming emails is a response to one of the pending emails that were sent out. The system 302 may monitor the incoming emails using the pending response list 306. For example, when an incoming email 308 (e.g., incoming electronic message 218) is received at the system 302, the system determines whether the incoming email is a response to one of the pending emails whose information are stored in the pending response list 306 (e.g., pending email 304). If the incoming email 308 is a response to the pending email 304 (whose information is included in the list 306), then the information on the pending email is removed from the pending response list 306, and the sender is notified that a response has been received for the pending email 304. In an aspect of the subject disclosure, the sender will be notified first that a response has been received, and the sender may be given an option to remove the pending email 304 from the pending response list 306, or to keep the email in the pending response list so that the system 302 may continue to monitor incoming emails to determine if any further responses to the pending email are received.

The user may decide to accept or override the determination of the system 302 based on various aspects such as, for example, contents of the email and the list of recipients. As the user accepts or overrides the determination made by the system 302, the system may learn such user behavior. For example, if the user overrides the determination of the system 302 that a response is expected for more than a predetermined number of times for emails including certain terms, the system learns this user behavior and reflects it in making future determinations on emails including similar terms.

If no response is received for the pending email 304 for a predetermined wait period, the system 302 may notify the sender that no response has been yet received for the pending email. Such notification may prompt the sender to follow up with the recipient regarding a response to the pending email 304. The reminder may also be generated and sent automatically by the system 302. A default value may be used for the predetermined wait period, such as, for example, one week. Other default wait periods may also be used. The sender may also be given an option to adjust the default value for the wait period. A separate user interface (not shown) may be provided at the system 302 such that the sender may adjust the default value at any time. The sender may also be provided with a user interface to enter a custom wait period for a specific pending email.

The system 302 may also provide the sender an option to manually stop the system 302 from monitoring responses for specific pending emails. The sender may have received a response to a pending email through a medium other than email. For example, the sender may have received a response to the pending email 304 via telephone. In such cases, the sender may access a user interface (not shown) where the sender manually removes the pending email 304 from the pending response list 306. Afterwards, the system 302 will not monitor the incoming emails for a response to the pending email 304.

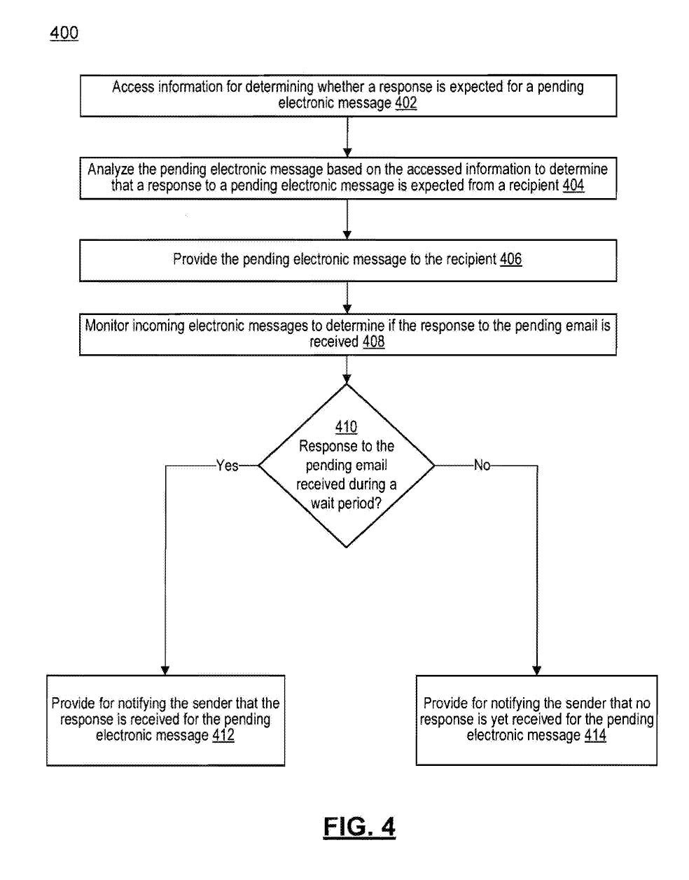

FIG. 4 illustrates an example flow diagram 400 of example operations for managing pending electronic message responses. The operations of FIG. 4 may be performed, for example, by the system 202.

In step 402, information for determining whether a response is expected for a pending electronic message (e.g., pending electronic messages 212a-b) is accessed. The information may be accessed, for example, at a datastore (e.g., datastore 210). In step 404, the pending electronic message is analyzed based on the accessed information to determine that a response is expected from a recipient for a pending electronic message (e.g., pending electronic messages 212a and 212b). In step 406, the electronic message is provided to the recipient. In step 408, incoming electronic messages (e.g., incoming electronic message 218) are monitored to determine if the response to the pending electronic message is received. In step 410, a determination is made whether the response to the pending electronic message is received during a wait period. If the response to the pending email is received during the wait period, in step 412, provisions are made to notify the sender that the response to the pending email is received. If no response is received during the wait period, provisions are made in step 414 to notify the sender that no response is yet received for the pending electronic message.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

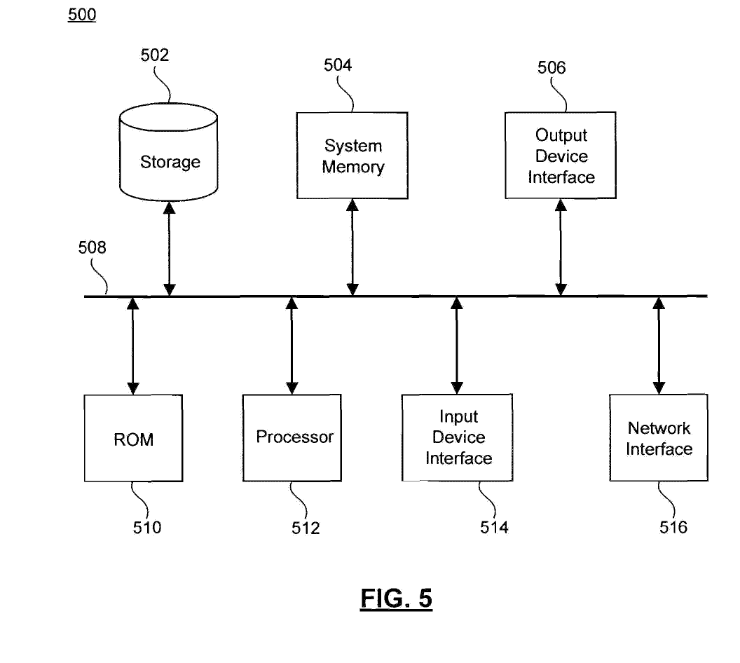

FIG. 5 conceptually illustrates an electronic system with which some implementations of the subject disclosure are implemented. Electronic system 500 can be a computer, phone, PDA, or any other sort of electronic device. Such an electronic system includes various types of computer-readable media and interfaces for various other types of computer-readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such as random access memory. System memory 504 stores some of the instructions and data that the processor needs at runtime. In some implementations, the processes of the subject disclosure are stored in system memory 504, permanent storage device 502, and/or ROM 510. For example, the various memory units include instructions for processing electronic messages in accordance with some implementations. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enable, for example, the display of images generated by the electronic system 500. Output devices used with output device interface 506 include, for example, printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms “display” or “displaying” means displaying on an electronic device. As used in this specification and any claims of this application, the terms “computer-readable medium” and “computer-readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”), a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects of the subject disclosure. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject disclosure or that such aspect applies to all configurations of the subject disclosure. A disclosure relating to an aspect may apply to all configurations, or one or more configurations. A phrase such as an aspect may refer to one or more aspects and vice versa. A phrase such as a “configuration” does not imply that such configuration is essential to the subject disclosure or that such configuration applies to all configurations of the subject disclosure. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

1. A computer-implemented method for managing pending electronic message responses, the method comprising:
accessing, using a processor, information for determining whether a response is expected for a pending electronic message;
analyzing the pending electronic message based on the accessed information, the analyzing comprising analyzing previous electronic messages from a sender to determine if the sender's previous electronic messages to a recipient received a response greater than a predefined number of times;
if so, determining that a response to the pending electronic message is expected from the recipient;
providing the pending electronic message to the recipient;
monitoring for the response to the pending electronic message, by monitoring incoming electronic messages to determine if the response to the pending electronic message is received; and
if no response is received within a predetermined period of time, providing for notifying a sender of the pending electronic message.

2. The method of claim 1, wherein the accessed information comprises a predetermined keyword, and wherein the analyzing the pending electronic message to determine that the response to the pending electronic message is expected comprises:
analyzing the pending electronic message to identify the predetermined keyword in the pending electronic message; and
determining that the response to the pending electronic message is expected if the predetermined keyword is identified in the pending electronic message.

3. The method of claim 1, wherein the accessed information comprises predetermined relationship information, and wherein the analyzing the pending electronic message to determine that the response to the pending electronic message is expected comprises:
analyzing the pending electronic message to identify a relationship between the sender and the recipient; and
determining that the response to the pending electronic message is expected if the identified relationship matches the predetermined relationship information.

4. The method of claim 1, wherein the accessed information comprises a response pattern information associated with previous electronic messages for which responses were received, and wherein the analyzing the pending electronic message to determine that the response to the pending electronic message is expected comprises determining that the response to the pending electronic message is expected based on the response pattern information.

5. The method of claim 1, further comprising including the pending electronic message in a pending response list, wherein the monitoring the incoming emails comprises monitoring the incoming emails to determine if the response is received for the electronic message included in the pending response list.

6. The method of claim 5, further comprising receiving the response to the pending electronic message included in the pending response list, and removing the pending electronic message from the pending response list.

7. The method of claim 5, further comprising receiving a stop command from the sender to stop monitoring for the response to the pending electronic message included in the pending response list, and removing the pending electronic message from the pending response list.

8. The method of claim 6, further comprising providing for notifying the sender that the response to the pending electronic message is received before removing the pending electronic message from the pending response list.

9. The method of claim 1, further comprising prompting the sender for a confirmation of the determination that the response to the pending electronic message is expected, wherein:
the monitoring for the response comprises monitoring the incoming electronic message if the confirmation is received; and
the generating the notification comprises generating the notification to the sender if the confirmation is received and no response is received within the predetermined period of time.

10. The method of claim 1, further comprising receiving from the sender a value for the predetermined period of time.

11. The method of claim 1, wherein the pending electronic message is an email.

12. A system for managing pending email responses, the system comprising:
a memory storing response expectancy information for determining whether a response is expected for a pending email and executable instructions; and
a processor coupled to the memory configured to execute the stored executable instructions to:
analyze the pending email based on the response expectancy information, the analyzing comprising analyzing previous emails from a sender to determine if the sender's previous emails to a recipient received a response greater than a predefined number of times;
if so, determine that a response to the pending email is expected from the recipient,
include the pending email in a pending response list,
provide the pending email to the recipient,
monitor incoming emails to determine if the response to the pending email included in the pending response list is received, and
if the response to the pending email is received, remove the pending email from the pending response list.

13. The system of claim 12, wherein the processor is further configured to:
after the monitoring the incoming emails, if no response is received within a predetermined period of time, provide for notifying a sender of the pending email that no response is received for the pending email within the predetermined period of time.

14. The system of claim 12, wherein the processor is further configured to:
after the monitoring the incoming emails, if no response is received within a predetermined period of time, provide a reminder to the recipient of the pending email that no response is received for the pending email within the predetermined period of time.

15. The system of claim 12, wherein the response expectancy information comprises a predetermined keyword, wherein the analyzing the pending email to determine that the response to the pending email is expected comprises:
analyzing the pending email to identify the predetermined keyword in the pending email; and
determining that the response to the pending email is expected if the predetermined keyword is identified in the pending email.

16. The system of claim 12, wherein the accessed information comprises predetermined relationship information, and wherein the analyzing the pending electronic message to determine that the response to the pending email is expected comprises:
analyzing the pending electronic message to identify a relationship between the sender and the recipient; and
determining that the response to the pending email is expected if the identified relationship matches the predetermined relationship information.

17. The system of claim 12, wherein:
the accessed information comprises a response pattern information associated with previous electronic messages for which responses were received; and
the determining that the response to the pending email is expected comprises determining that the response to the pending email is expected based on the response pattern information.

18. The system of claim 12, wherein the processor is further configured to notify the sender that the response to the pending email is received before removing the pending email from the pending response list.

19. The system of claim 12, wherein the processor is further configured to receive from the sender a value for the predetermined period of time.

20. A non-transitory machine-readable storage medium comprising machine-readable instructions for causing a processor to execute a method for managing pending email responses, the method comprising:
accessing a predetermined keyword for determining whether a response is expected for a pending electronic message;
analyzing the pending electronic message to identify the accessed predetermined keyword from a pending email and to determine if a sender's previous electronic messages to a recipient received a response greater than a predefined number of times;
determining that the response to the pending email is expected based on the identified predetermined keyword if the accessed predetermined keyword is identified in the pending electronic message and if the sender's previous electronic messages to the recipient received a response greater than a predefined number of times;
including the pending email in a pending response list;
providing the pending email to the recipient;
monitoring incoming emails to determine if the response to the pending email included in the pending response list is received;
if the response to the pending email is received, removing the pending email from the pending response list; and
if no response is received within a predetermined period of time, providing a reminder to the recipient of the pending email that no response is received for the pending email within the predetermined period of time.
